(19) United States
(12) Patent Application Publication
(10) Pub. No.: US 2010/0074328 A1
(43) Pub. Date: Mar. 25, 2010

(54) METHOD AND SYSTEM FOR ENCODING AN IMAGE SIGNAL, ENCODED IMAGE SIGNAL, METHOD AND SYSTEM FOR DECODING AN IMAGE SIGNAL

(75) Inventors: Fei Zuo, Eindhoven (NL); Stijn De Waele, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,377

(22) PCT Filed: Dec. 12, 2007
(86) PCT No.: PCT/IB07/55051

§ 371 Date: Jun. 16, 2009

(30) Foreign Application Priority Data
Dec. 19, 2006 (EP) 06126512.0

(51) Int. Cl. H04B 1/66

(52) U.S. Cl. 375/240.03; 375/240.12; 382/236; 375/E07.245

(57) ABSTRACT

An image signal is encoded to reduce artifacts. In an original image frame (F) one or more gradual transition areas (R) are identified, in a decoded frame (F) corresponding one or more gradual transition areas (R) are identified, functional parameters describing the data content of the one or more gradual transition areas of the original image frame are established and position data (P) for the positions of the one or more corresponding areas (R′) in the decoded frame (F′) are established. Replacing the content of the areas R′ in the decoded frame with the reconstructed content of the areas R in the original frame improves the quality of the decoded frame.

### FIELD OF THE INVENTION

The invention relates to a method and system for encoding an image signal in which method or system artifact reduction is applied.

The invention also relates to a method and system for decoding an image signal.

The invention also relates to an image signal.

### DESCRIPTION OF PRIOR ART

In encoding of image signal artifacts occur. One type of artifacts frequently occurs in the coding of smooth gradual-transition areas within an image. These artifacts show as blockiness, color distortion, and wobbling effect during temporal evolution. These artifacts are mainly caused by quantization during encoding and other information loss during the encoding procedure and is more visible and annoying than at more textured areas.

One possible solution to the above problem is to use adaptive quantization, which allocates more bits (using small QP) to the smoother areas and fewer bits on more textured areas. However experiments with state-of-the-art codec FFMPEG do not give satisfactory results, with still quite visible artifacts at even low QPs. Also using low QPs at smooth gradual transition areas allocates a disproportionate amount of available bits to areas that, in fact, are relatively simple in image content. In circumstances, for instance when only a limited amount of data space is available, this will form a problem.

Another possible solution is to use pure post-filtering by applying a de-blocking and/or smoothing filter to the decoded images. However, experiments in which use was made of already in-loop de-blocking filters showed that the artifacts were not removed, probably due to the large extent of the gradual-transition areas. Furthermore, it is generally difficult to apply a post-filter of such kinds because of the following:

1. It is difficult to determine completely at the decoder side where to apply the post-filtering. Since the encoded gradual-transition areas are already distorted (not smooth anymore), it is very difficult to know whether the original frame is smooth or not.
2. Post-filtering requires the selection of the right filter parameters (aperture size, etc) to avoid over- or under-filtering. The type of filters to use is determined by many factors, such as the extent of the area and the strength of the artifacts, which can be influenced by encoding parameters such as quantization parameters. However, the inventors have found that even manual tuning of parameters cannot lead to desired results. Furthermore, this type of filtering can hardly remove the temporal artifacts occurring in gradual-transition areas.

### SUMMARY OF THE INVENTION

It is an object to provide a method and system for encoding an image signal, an encoded image signal and a method and system for decoding an encoded image signal which can inter alia be used to yield better quality images for an amount of compression (in particular in gradual regions such as the sky), and furthermore allows other applications to perform better.

The method of encoding is characterized in that of a first image frame one or more gradual transition areas are identified, in a second image frame derived from the first image frame corresponding one or more gradual transition areas are identified, establishing functional parameters describing the data content of the one or more gradual transition areas and establishing position data for the positions of the one or more corresponding areas in the second related image.

The method makes use of encoder knowledge about gradual-transition areas. In the invention during encoding for the first image frame gradual transition areas are identified. Corresponding areas in the second related image frame are also identified. Functional parameters, for instance the parameters of a spline function for the data content in the first image, are generated. This allows characterizing the image content of the gradual transition areas with a relatively small amount of bits. Since the positions of corresponding areas in the second, derived, image frame are also identified it is possible to construct with a high level of accuracy the gradual transition areas at the correct positions of the second, derived, image frame. The construction does not suffer from the image errors typical for encoding/decoding.

During deriving the second frame from the first frame artifacts are generated. Deriving can for instance be encoding and/or decoding, an encoded and/or decoded frame is derived from an original frame.

Such artifacts are, as explained above, difficult to correct. The invention provides a simple solution which does not require much additional data.

The construction at the decoder side will introduce some errors, basically smoothing errors, and possibly some location errors, but will remove any errors due to the derivation process (encoding/decoding, quantization etc.) or allow to improve the image. It has been found by the inventors that the advantages outweigh the disadvantages for gradual transition areas.

It is remarked that segmentation or specific area detection at a decoder side only is known. However, such autonomous segmentation will not solve the problem, since the encoded image is already distorted and the original image is not available. It is also known to try to adapt encoding parameters, for instance by using adaptive quantization, dependent on the pixel content. Such procedure however, even if areas are defined and corresponding encoding parameters are generated, do not provide the possibilities and advantages of the present invention. In fact, as explained above the standard way of dealing with gradual transition areas in this manner still leaves quite visible artifacts while yet increasing substantially the amount of data needed, since a low QP is used.

The gathered functional parameters allow filling the corresponding gradual transition areas in the derived image with a functional representation of the data in the original image or an improved image.

The position data provides control information to identify the gradual transition areas to be constructed.

The method and system of encoding offers the following advantage:

The method makes use of encoder knowledge about both the original and derived image frames. The control information can be optimally selected to give the best gradual transition area identification and post-processing. This gives important advantage over doing autonomous post-processing at the derived image frame only.

In a first embodiment the derived image frame is a decoded frame and the first frame is an original frame. The method comprises an encoding and decoding step to provide for a decoded frame derived from the original frame; the system comprises an encoder and a decoder to encode the original frame in an encoded frame and provide a decoded frame from the encoded frame.

The invention allows a strong reduction of encoding/decoding errors in gradual transition areas. In effect information is generated to replace at the decoder side one or more of the identified gradual transition areas in the decoded image frame with data derived from the information. In embodiments the decoded frame and encoded frame are used outside the encoder loop itself.

In other embodiments the decoded frame is decoded inside the encoder loop. Encoders comprise one or more encoder loops wherein within the loop a decoded frame is generated and the decoded frames are used to improve the encoding. Inside an encoder loop frames are decoded for various reasons in various methods. One of the reasons is to generate B or P frames from 1 frames. Using the method it is possible to improve the quality of the decoded frame used within the encoder loop. This will have a beneficial effect on any method steps performed within the encoder loop with said decoded frame.

Preferably in the encoding method and system one or more thresholds are used for identification of gradual transition areas.

The inventors have found that the invention is most useful for gradual transition areas which have a substantial size. In this embodiment only areas with sufficiently large size, above a size threshold are selected as gradual transition areas. Smaller areas are not used in this embodiment of the invention. Preferably the size threshold is dependent on the quantization used during encoding-decoding wherein the threshold size increases as the quantization becomes coarser. The size of the threshold increases as the coarseness of the quantization increases. As the quantization increases the distance between visible block edges increases.

Preferably a floodfill algorithm is used. A floodfill algorithm is an algorithm is which a start is made from a seed pixel, this is the seed of the area, adjacent pixels are defined to belong to the same gradual transition area if the difference in one or a combination of characteristic data does not exceed a threshold. Preferably the floodfill threshold is dependent on the matching between the reconstruction of the gradual transition area in the second image and the original gradual transition area. Typically the threshold increases as the coarseness of the quantization increases.

In a simple embodiment the characteristic data is the luminance and the threshold is for instance a value of 3 in luminance. In more sophisticated embodiments a combination of luminance data and color data and a multidimensional threshold may be taken.

In yet other embodiments, independent of the use of a floodfill algorithm, wherein the image frame comprises 3-D information the so-called z-depth map, the characteristic data may be used to find gradual transition areas within the depth map. The depth map is, during encoding and decoding, or when an intercoded frame is made from an intercoded frame, subject to deblocking and other errors. Such errors lead to strange 3D effects wherein, in a gradual transition area, the apparent depth jumps from one value to another. The invention allows strongly reducing this effect.

Using a floodfill algorithm allows using a segmentation algorithm that is most suitable for identifying the gradual-transition areas. The control information can be described in a very concise way and it can be also easily optimized for the derived image. Identifying the seed pixels and the parameters for the floodfill algorithm allows reconstructing the gradual transition areas. It allows to use for the control information only very few bits, which is more advantageous than transmitting (or store) a complete description of the area (e.g. boundary, mask map).

### BRIEF DESCRIPTION OF THE DRAWINGS

These and other advantageous aspects of the invention will be described in more detail using the following figures.

FIG. 1 shows the processing flow of a post-processing method, including a method for encoding and decoding according to an embodiment of the invention;

FIGS. 2 and 3 illustrate image errors using known techniques;

FIGS. 4, 5 and 6 illustrates an embodiment of the invention;

FIG. 7 illustrates a second embodiment of the invention;

FIG. 8 illustrates a further embodiment of the invention;

FIG. 9 illustrates a further embodiment of the invention;

FIG. 10 illustrates yet a further embodiment of the invention.

The figures are not drawn to scale. Generally, identical components are denoted by the same reference numerals in the figures.

### DETAILED DESCRIPTION OF PREFERRED EMBODIMENTS

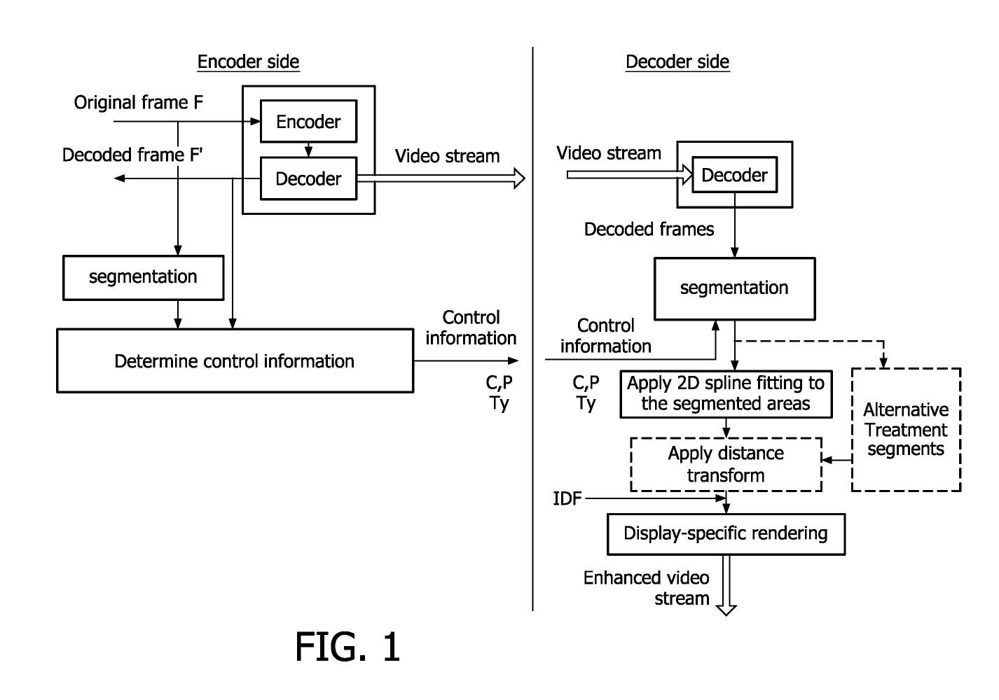

FIG. 1 shows a processing flow of an embodiment of our invention used as a post-processing method. This is illustrated in the following:

### Encoder Side:

1. Encode frame F and obtain its corresponding decoded frame F'.
2. Detection of gradual-transition areas in frame F. Frame F is then the first image frame, frame F′ the derived image frame.

For frame F, first mark all pixels as unprocessed. Scan frame F in the order of left-to-right and top-to-bottom. If pixel at location (xs, ys) is unprocessed, select it as a seed, and apply a floodfill algorithm. The algorithm starts from the selected seed and grows the area as long as the luminance difference between adjacent pixels does not exceed a predefined threshold T. This threshold can be set as a small number (e.g. 3). This is because gradual-transition areas in original frame have the characteristics that neighboring pixels in these areas have very similar luminance values (although the whole area can have a wide distribution of luminance values). Mark each pixel in the area as processed and label the area as R. Thus in the first image frame the gradual transition areas are identified. This process will continue until all pixels from frame F are processed. For all labeled areas, preferably only those with sufficient large size (e.g. above a size threshold) are selected as candidate areas for post-processing. This amounts to a threshold in identifying the gradual transition areas in the original frame F. In the figure this is indicated by the block segmentation.

3. Area analysis based on both F and F′.
For each labeled area R in frame F, starting from the same seed (xs, ys), perform a floodfill algorithm to segment the corresponding area R′ in frame F'. Since frame F′ is already distorted with possible strong artifacts, it is not possible to use the same threshold T as used in frame F to segment the same area. Therefore, we use the following strategy to find an optimal T′ for segmenting the same area from frame F′.

Set T′=T.
Repeat
{

Use floodfill to segment the area by threshold T′ (neighboring pixel

difference).

Compute overlapping area L between segmented area R′ in frame F′

and area R in frame F as compared with the area of R (R′).
T′=T′+1.
}

T′ is chosen such that R′ closely matches R.

In this way, the optimal threshold T′ is found for segmenting area R′ in frame F′, avoiding under—or over—segmentation at the decoder side. Thus in the derived image frame gradual corresponding gradual transition areas are identified.

4. Generation of post-processing data content control information for each area.

For each gradual-transition area R in frame F, perform e.g. a 2D spline fitting or other interpolator/smoother strategy (e.g. if the gradual transition has some texture aspects to it—e.g. a small patterned noise—, the interpolation may involve texture model parameters, i.e. it may be a more complex interpolation involving e.g. model-based texture regeneration), to the pixel luminance in area R. A 2D spline consists of piecewise basis functions (e.g. polynomials) to fit for arbitrary smooth areas. The complexity of the spline is controlled by the number of basis functions used. The use of a spline fitting algorithm to automatically select the minimum number K of basis functions is preferred, such that the average difference between R and the fitted surface is below a pre-defined error threshold. This establishes functional parameters for the gradual transition areas. In this example a spline function is used, however, other fitting functions can be used, for instance for relatively small areas simple polynomial fitting. In the figure this is indicated by the block “determine control information”.

In a preferred embodiment a quality-of-fitting (e.g. fitting error) is performed at this stage to determine whether the fitted surface gives a faithful representation of the original frame. If not, the area is not selected as candidate for post-processing. This is an example of application of a threshold after establishing the functional parameters.

Next, the post-processing control information for each area is then generated at the encoder side as:

Area description (control information)
{
Seed location (xs,ys).
Segmentation threshold for the floodfill at the decoder side (T′).
Complexity control of the spline function (K).
(Optional: spline coefficients).
}

The seed location and the segmentation threshold determine the position of the corresponding gradual segmentation areas in the derived image F′. They form position data. In FIG. 1 this is schematically indicate by P for position in the control information.

The complexity control of the spline function and the spline coefficients provide for functional parameters for the data content within the gradual segmentation areas. In FIG. 1 this is schematically indicated by C for Content in the control information. The encoder comprises a generator for generating the control information. The control information may comprise also type identifying data. Gradual transition areas may be for instance identified as “sky”, “grass” or “skin”. At the encoder side, using the information of the original image, this can be done with a much higher accuracy then at the decoder side. At the encoder side the color, size and position of the gradual transition area is often a good indication of the type of gradual transition area. This type information (in the figure denoted by Ty for type) may be inserted into the control information in the data signal. This allows at the decoder side to identify specific kinds of gradual transition areas.

The control information is transmitted (or stored) as side information to the decoder. An example would be that they are carried by the SEI messages defined in current H.264/AVC standard. The image signal then comprises additional control information, not present in the known image signals and is, by itself, an embodiment of the invention. Also any data carrier comprising the data signal according to the invention, such as a DVD or other data carrier, forms an embodiment of the invention. The invention is thus also embodied in a data signal comprising image data and control information wherein the control information comprising functional parameters for the data content of gradual transition areas and position data for the gradual transition areas. Such a signal can both be used by standard decoders as by decoders in accordance with the invention. At the decoder side, in accordance with the method of decoding of the invention, the following steps are performed:

### Decoder Side:

1. Identify segmented gradual-transition areas based on the position information P received from the encoder side (seed (xs, ys) and threshold T'). The decoder comprises an identifier for identifying position data for gradual transition areas. The gradual transition areas in the decoded frame (i.e. segmentation of the decoded frame) are thereby identified. The decoder has a reader for reading the information C and P.
2. Use the Apply 2D spline fitting to the area with K basis functions (complexity control). The decoder comprise an identifier for identifying functional parameters for the data content of gradual transition areas. Within the concept of the invention ‘functional parameters’ is to be broadly understood. These parameters may comprises any data indicating the type of function to be used (spline function, simple polynomial, other function), parameters indicating the complexity of the function (the number of terms in a polynomial for instance), the coefficients of the terms, the type of data it concern (luminance, color coefficients, z-value) etc or any combination of such data. Also the parameters may be given in an absolute form, or in a differential form, for instance with respect to a previous frame. The latter embodiment can reduce the number of bits needed for the parameters. The same type of function may be used throughout a frame or series of frames, or different functions may be used, for instance dependent on the size of the gradual transition area or the type of data concerned. Also, for different data, such as for instance luminance and depth, the gradual transition areas may or may not coincide. In this embodiment the content information is used.

Alternatively the identified segments could undergo an alternative treatment. For instance, the spline functions could be altered to enhance or decrease the gradual transition over the area. The sky could be made more blue, the grass more green or a grey sky area could be replaced by a blue sky. In any case the gradual transition areas, after having been identified and processed are inserted into the decoded frame replacing the original corresponding parts. The end result is that at least some the gradual transition parts which were susceptible to blockiness due to quantization during encoding-decoding are replaced by other parts. In particular when the control information comprises a type information Ty. The type information “skin or face” may for instance trigger a face improvement algorithm.

In general, the present invention allows a synchronization of the shape of segments from the encoder (original or estimated decoded image) and the decoder. The encoder, may know the decoding strategy, and can then determine what is the best way to segment (e.g. which statistics, methods, parameters, . . . ) should be used and transmit this as side information along the compressed image signal (this may even involve a compression software algorithm code). Having such a better segmentation can be used for more optimal (especially large extent) artifact removal, and hence realizing a better compression/quality ratio, but also other applications may benefit (e.g. when having a person well-segmented, higher order image processing such as person behavior analysis will benefit).

Lastly, also corrective data for subregions in the segments may be transmitted. E.g. a sky in a still photo or successive video images may be very cheaply represented with image data and an optimal spline for the gradually changing blueness, but in some regions or pictures there may be a couple of regions which are smoothed out (e.g. small cloud stroke). This can be corrected with a little segment-relative pixel correction data.

3. Preferably, in order to avoid an abrupt transition between the post-processed area, and the other, unaffected parts of the image, a distance transform is applied to identify a ‘transition band’ between a gradual-transition area and its adjacent areas. For example a (non)-linear weighting technique is used to improve the transition over these boundary areas. In the transition band a smoothing function is applied to smooth the transition between the filled-in area and adjacent areas.
4. The result of the spline fitting is of floating-point accuracy, which can then be rendered on any display settings (e.g. 8-bit or 10-bit color depth).

The end result is an improved decoded frame IDF.

This is sent to a display specific rendering.

### Additional Remarks:

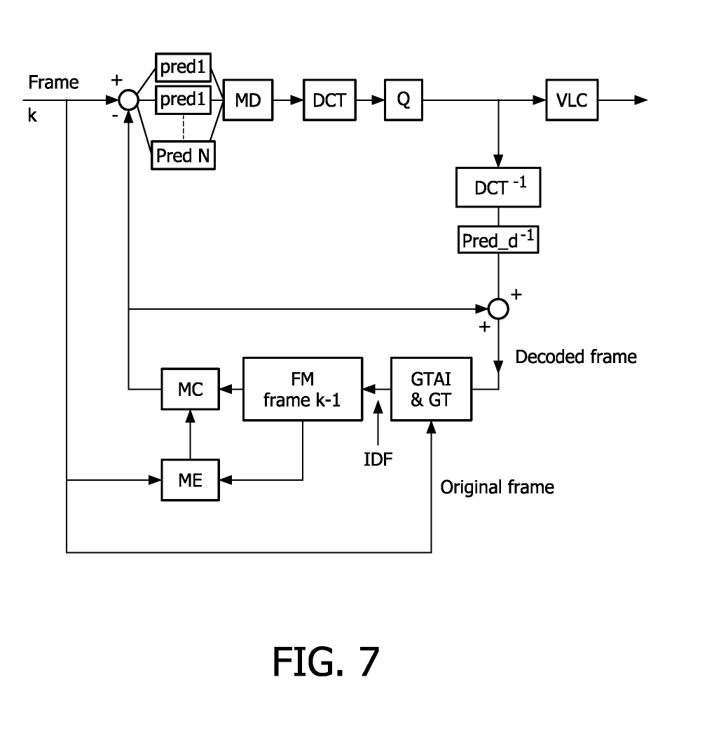

1. The spline model (coefficients) can be transmitted to the decoder, if the decoder has certain computation constraints.
2. One example in our experiments shows the PSNR improves by up to 2-4 dB (measured on gradual-transition area only) by applying the invention. In this case, the spline fitting should be performed on area R in the original frame F. Therefore, an embodiment of the invention is that the method is used also used as in-loop processing embedded in the encoder. Such an embodiment will be further explained in a further embodiment shown in FIGS. 7, 8 and 9.

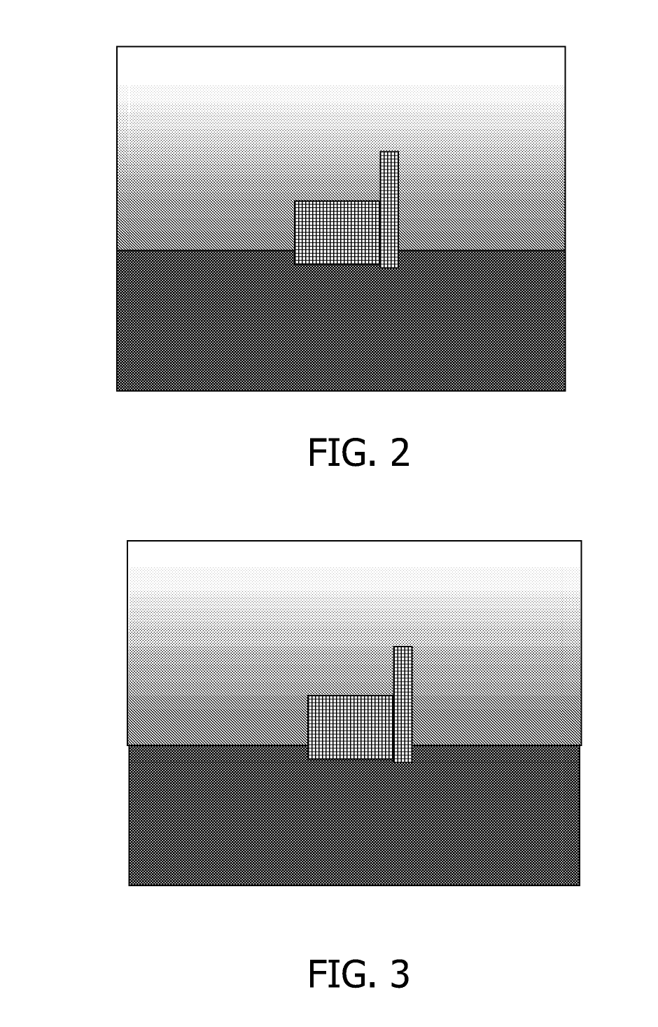

In FIGS. 2 and 3 a typical error in decoded images having a gradual transition areas is illustrated. FIG. 2 shows the original frame. The top part, e.g. the sky, shows a gradual transition from white at the top to grey at the horizon. In this case 9 shades of grey transitioned. FIG. 3 shows the image after decoding. Quantization has occurred. The quantization shows as bands of grey and the distinction between the bands (although only one shade of grey) even if the grey level difference is only small, can be easily spotted by the human eye.

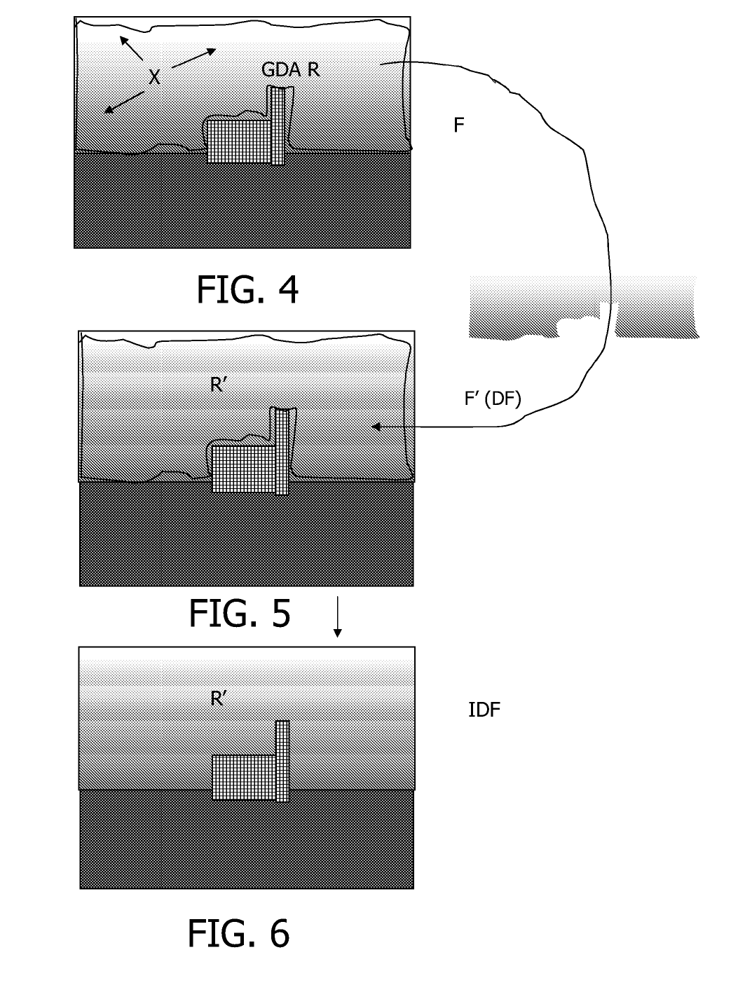

FIGS. 4 to 6 illustrate the method of the invention. The gradual transition area R is identified in the original frame F. For instance from a seed point, indicated by the cross a floodfill algorithm, schematically indicated by arrows from the seed point, the gradual transition area (GTA) R is found. For this gradual transition area a best fitting spline function is generated to best describe the luminance within the area R. The area is indicated by the line. In theory of course the line should coincide with the frame of the image, the horizon and outline of the factory. In this figure a line slightly inward is drawn so that the GTA is visible.

In the decoded frame F′ a corresponding gradual transition area R′ is identified. The spline function of area R is then applied to area R′ which in effect replaces the area R′ of the decoded frame F with a parameterized reconstruction of the corresponding area R of the original frame F. Since gradual transition areas, by the very fact that they show a gradual transition, can be parameterized to a high degree of accuracy, this renders an improved decoded frame IDF in which the grey level steps due to quantization effects are no longer visible.

In experiments it has been found that an improved rendering quality of the sky area without hampering the details in other parts of the image is found. An improvement of 2-4 dB in PSNR value was found which is clearly visible to the naked eye.

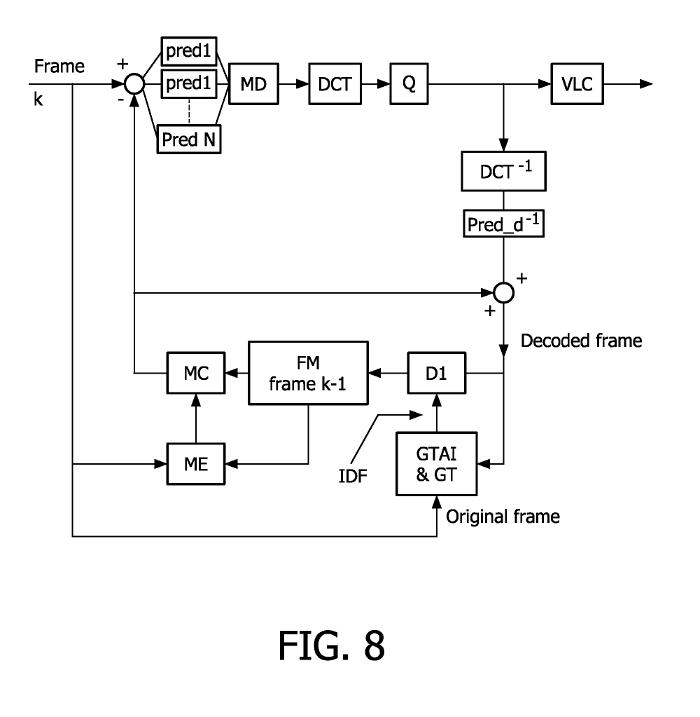

FIGS. 7 and 8 illustrate a further embodiment of the invention.

In the example shown in FIG. 1 the invention is used out of the loop of the encoder. At the decoder side an improved decoded frame IDF is made.

However, the invention can also be used in a loop of the encoder. As is well know, in the encoder a decoded frame is also used in a loop within the encoder for motion estimation and motion compensation when B and P frames are generated from I frames. The same artifacts as shown in FIG. 3 will be present in decoded frames within the encoder and the artifacts will affect the accuracy of motion estimation and motion compensation and the quality of B and P frames. This is true for any arrangement where, inside the encoder a decoded frame, or a representation thereof is made. As explained above the invention provides at the decoder an improved decoded frame IDF. But the same or a similar improvement can be obtained in a decoded frame used inside (so in-loop) within an encoder. This will for instance allow a better motion estimation and motion compensation and thus improved rendering of B and P frames. FIG. 7 illustrates this embodiment. Inside the encoder, prior to using a decoded frame for motion estimation (ME) and motion compensation (MC) the original frame and the decoded frame are submitted to GTAI, Gradual transition area identification (i.e. position information), and GT, gradual transition area transformation, i.e. the transformation of gradual transition areas in the decoded frame with a parameterized representation of the corresponding gradual transition area in the original frame. The end result is an improved frame to be used for ME and MC and thus improved rendering of the B and P frames. Of course, at the decoder side the corresponding algorithm have to be used to perform the same motion estimation and motion compensation. Information on how to find the position of the gradual transformation areas and the function to fill the areas preferably is included in the data stream. This information, however, does not require much bits.

FIG. 7 illustrates an embodiment in which parts of the decoded frame are replaced. FIG. 8 shows a variation on this embodiment.

In some more sophisticated methods for motion estimation and motion compensation there is the liberty of choosing, as the starting point for the calculation of the motion estimation and motion compensation, not necessarily the previous frame (k frame), but the frame (k−1) before that or the one before that (k−2). This can be done for any part of the frame. This selection scheme can be extended by including in the set of frames to be considered one or more IDF frames made according to the invention. Schematically this is illustrated in FIG. 8 where a choice can be made in decider D1 between using the ‘original decode frame” and the improved decode frame IDF for motion estimation and motion compensation.

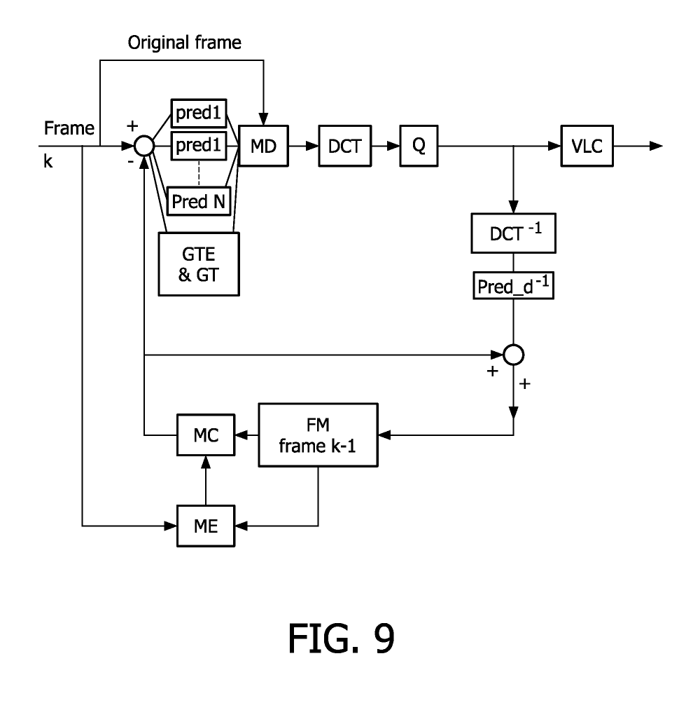

There are encoders in which several predictions of decoded frames or parts of frames are made which are compared to the original frame to find the best encoding/decoding mode. Within this framework, the invention may also be used by adding to the list of possible encoding methods a method in which gradual transition areas are identified and the parameters are calculated, and in the decoded frame the gradual transition areas of the decoded frame are replaced with a reconstruction of the corresponding gradual transition areas of the original frame. In FIG. 9 this is illustrated by having next to in the boxes indication pred1, pred 2, i.e. predictions of various encoding/decoding methods, a box with GTAI and GT. In the decider MD, by comparing the outcome of the predictions to the original frame or part of the original frame, the best possible mode of encoding/decoding is chosen for a frame or, more likely for a part of a frame, such as a macroblock.

So, in FIG. 7 gradual transition interpolations are used as post-processing in I-frames, very similar to the out-loop case. The difference is that the gradual transition interpolation is applied to the I-frame and then used as a (motion compensated) reference for P and B frames. The additional info that is added to the video stream is the same as for out-loop: both segmentation control parameters and model parameters. The second in-loop mode is somewhat different. Here, the interpolated frame is used as a possible encoding mode aside from other prediction modes. If the gradual transition model is selected as an interpolator, this is indicated in the stream as is done for any other prediction mode. However, the basic requirements are still to find the gradual transition areas in the original frame and the corresponding areas in the decoded frame are found and the decoded frame is generated within the encoder which has an encoder loop and the artifact reduction is applied within the encoder loop.

The abbreviations in FIGS. 7 to 9 stand for:

### DCT=Discrete Fourier Transform

Q=quantizer
VLC=variable length coding
Pred=prediction mode
Pred_d=decided prediction
GTAI=gradual transition area identification
MD=Mode decision
GT=gradual transition area transformation
DCT⁻¹ inverse DCT

The invention relates to a method and system of encoding, as well as to a method and system of decoding, as described above by way of example.

The invention is also embodied in an image signal comprising encoded image signals and control information comprising functional parameters describing the data content of the one or more gradual transition areas and position data for the positions of the one or more corresponding areas. This holds both for the embodiments shown in FIG. 1 as for the embodiments in FIGS. 7 to 9. The control information may comprise data in accordance with any, or any combination, of the embodiments described above. As explained above the data signal can be used to replace in the decoded signal gradual transition areas with a reconstruction of the corresponding areas in the original frame, but the invention can also be used to alter these areas at will, for instance replace them with areas of a different color or another representation.

The artifact removal examples described here are just non-limitative illustrations of a goal of the invention to make the reconstructed/decoded image look closely like the encoded original. The feature image should not be seen limiting in that only successive images are encoded. A transmitting end artist can use this method also to specify several “original” (subregion) images for the receiver. E.g. he can test on the transmitting side what the effect is of a simple spline interpolation or a computer graphics complex sky regeneration. The signal can then contain both sets of correction parameters. A decoder can select one dependent on its capabilities, or digital rights paid, etc.

The embodiments for enhanced visual quality of the invention can be used outside the encoder loop (FIG. 1′) as well as inside the encoder loop (FIGS. 7 to 9) where decoded frames are used or predictions of such decoded frames are used.

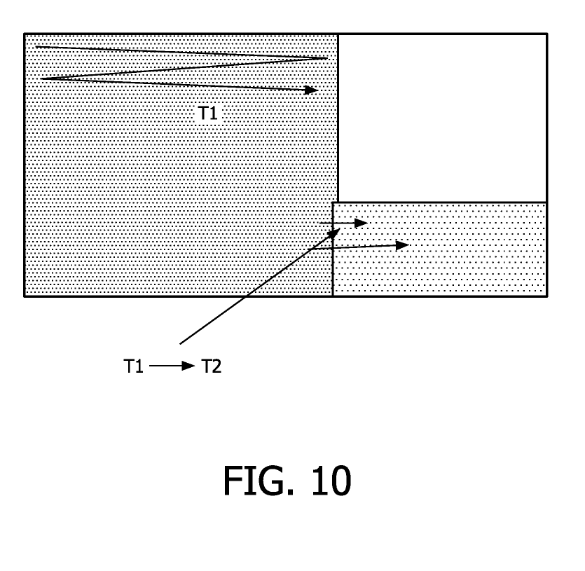

In regards to the threshold, it is remarked that the thresholds can, in simple embodiments, be fixed thresholds (e.g. sent once for all the sky segmentations in an entire film shot), but also may be adaptable thresholds (e.g. a human may check several segmentation strategies, and define—for storage on a memory (e.g. blu-ray disk), or (real-time or later) television transmission etc.—a larger number of optimal thresholds, as e.g. illustrated with FIG. 10). The main idea is that the encoder performs a segmentation strategy and then after finding a correct parameterized one that fits the desired image region/which can be done off/line, e.g. by a human artist guidance, send the parameter with the image signal) e.g. SEI message so that the decoder can also simply perform the correct segmentation.

FIG. 10 shows an example of a region growing segmentation. The desired region to be segmented (dark grey) is next to a dissimilar region (white) and a rather similar region (light grey). The to be segmented region is scanned in a zigzag line. Because the zigzag line scan line is followed, no additional data is needed for synchronizing the growing segments at encoder and decoder. A running statistical descriptor (e.g. the average luminance or grey level with tolerances is calculated and e.g. initialized as metadata. If a current pixel or block does not deviate more than a value T1 from the running amount, the pixel/block is appended to the segment. However it could be that the dissimilar region is erroneously appended since the difference is less than T1. This can be corrected by adapting the threshold to T2, in this figure schematically indicated by T1→T2. This correction can be performed by sending an updated T2 for this position at the scan line. The threshold T1, T2 is then not a fixed value but an adaptive value. The segmentation can be done on grey value, but could also be done on texture. One could first convert the image with texture characterizing algorithms the textured image to a grey value image and apply grey value segmentation, but one could also directly compare texture measures in the statistics, e.g. one could calculate a number of local pattern shape measures. In such a strategy the SEI information could be e.g. data of the algorithm which calculates the roundness, or locally adapted roundness filters.

E.g. segmentation may be done on the basis of calculating:

$$G = \frac{1}{N} ( {\sum }_{allpixels} \vert {C}_{i}^{R} - {C}_{i}^{A} \vert + {\sum }_{allmeasures} \vert {CM}_{i}^{R} - {CM}_{i}^{A} \vert )$$

in which C is the number of pixels belonging to a particular grey value and/or color class i (e.g. between 250 and 255) of a region to be appended A (e.g. an 8×8 block) compared to a representative averaged statistic in the same class i, times the same amount of pixels as in A, for the current segment R.

The second term compares classes of measures of local texture e.g. calculated shapes (e.g. a first operator S1 classifies the length of the texture elements as low if <4 pixels and high if larger, and a second S2 value indicates the roundness into round or elongated, and the combination (round, small) is class CM i=1, etc. The metric counts the number of such local subregions in the block to be appended and the running segment statistic, again indication how similar—texture-wise—a neighboring region is to the current segment; N is a normalizer.

As correction strategy to counter the visual quality loss of the “standard” (DCT) compression one can e.g. send a texture synthesis model+parameters. In this example, the segmentation determining parameters will e.g. be the algorithms to determine the roundness and size, the above G-function, and thresholds above which G indicates dissimilarity, and perhaps a segmentation strategy (running merge, quadtree, . . . ). So also for texture a gradual transition can be scene as a region in which the properties don't change substantially.

Having the information for the segmentation transmitted, in embodiments of the method and the signal in accordance with the invention information regarding the image operation to be performed at the encoder side is also transmitted and included in the signal, e.g. to make the cleaned up/reconstructed decompressed image look as good as possible like the original, or a nice looking deviation therefrom accepted by the human operator (e.g. looking even more sharp than the captured original). In the example of sky deblocking this would be e.g. filter supports or interpolation parameters), in the grass clean-up or replacement example this could be e.g., grass generation parameters. This information regarding the image operation to be performed at the decoder side would then form part of the functional parameters C determining the content of the gradual transition area. Thus functional parameters C for determining the content are all parameters that allow to fill and/or replace and/or manipulate the content of the segmented areas.

The invention is also embodied in any computer program product for a method or device in accordance with the invention. Under computer program product should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

It will be clear that within the framework of the invention many variations are possible. It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope.

For instance, the method may de used for only a part of the image, or different embodiments of the method of the invention may be used for different parts of the image, for instance using one embodiment for the center of the image, while using another for the edges of the image.

Use of the verb “to comprise” and its conjugations does not exclude the presence of elements other than those stated in the claims. Use of the article “a” or “an” preceding an element does not exclude the presence of a plurality of such elements.

1. Method for encoding an image signal in which method artifact reduction is applied, wherein of a first image frame (F) one or more gradual transition areas (R) are identified, in a second image frame (F′) derived from the first image frame corresponding one or more gradual transition areas (R′) are identified, functional parameters (C) describing the data content of the one or more gradual transition areas of the first frame are established and possibly position data (P) for the positions of the one or more corresponding areas (R′) in the second, derived, image frame (F′) are established.

2. Method for encoding as claimed in claim 1, wherein the second, derived image frame is a decoded frame (F′) and the first frame is an original frame (F).

3. Method for encoding as claimed in claim 2, wherein the decoded frame is generated within an encoder having an encoder loop and artifact reduction is applied within the encoder loop by replacing the content of one or more of the corresponding gradual transition areas (R′) with a reconstruction of the content of the one or more gradual transition areas (R).

4. Method for encoding as claimed in claim 1, wherein one or more thresholds are used for identification of gradual transition areas (R, R′).

5. Method for encoding as claimed in claim 4, wherein the threshold is a size threshold.

6. Method as claimed in claim 5, wherein the size threshold is dependent on the quantization (QP) used during encoding-decoding wherein the threshold size increases as the quantization becomes coarser.

7. Method as claimed in claim 4 wherein the threshold is a floodfill threshold.

8. Method for encoding as claimed in claim 7, wherein the floodfill threshold is determined by comparing a reconstruction of a gradual transition area from the second image to an original transition area from the first image, such that the overlapping area between the two is maximized.

9. Method for encoding as claimed in claim 1 wherein a spline function is used for providing the data content of the one or more gradual transition areas (R).

10. System for encoding an image signal in which system artifact reduction is applied, wherein the system comprises a first identifier for identifying of a first image frame (F) one or more gradual transition areas (R), a second identifier for identifying in a second image frame (F′) derived from the first image frame corresponding one or more gradual transition areas (R′), and a generator for generating functional parameters (C) describing the data content of the one or more gradual transition areas and position data (P) for the positions of the one or more corresponding areas in the second, derived, image frame.

11. System for encoding an image signal as claimed in claim 10, wherein the first and second identifier are arranged to identify gradual transition areas in an original image frame and a decoded image frame.

12. System for encoding an image signal as claimed in claim 11, wherein the first and second identifier are arranged in an encoder loop.

13. System for encoding an image signal as claimed in claim 10, wherein the first and or second identifier is arranged to apply one or more thresholds for identification of gradual transition area.

14. Image signal comprising image data and control information wherein the control information comprises functional parameters (C) for the data content of gradual transition areas within a frame and position data (P) for the gradual transition areas within a frame.

15. Image signal as claimed in claim 14, wherein the control information comprises a type identification (Ty) for one or more gradual transition areas.

16. Image signal comprising image data and segmentation determining parameters, usable for synchronizing an image segmentation at encoder and decoder side.

17. Image signal as in claim 16, in which the segmentation determining parameters comprise at least two thresholds for respective positions in the image, the thresholds determining whether successive image pixels will belong to the same segment.

18. Method for decoding an image signal wherein the image signal comprising image data and control information wherein the control information comprises functional parameters (C) for the data content of gradual transition areas and position data (P) for the gradual transition areas wherein the control information is read, the gradual transition areas are identified and processed and inserted in the decoded image frame.

19. Method for decoding an image signal as claimed in claim 18 wherein from the functional parameters the data content of the gradual transition areas is reconstructed.

20. Method for decoding an image signal as claimed in claim 18 wherein a ‘transition band’ between a gradual-transition area and its adjacent areas is identified and in the transition band a smoothing function is applied to smooth the transition between the gradual transition area and adjacent areas.

21. Decoder for decoding an image signal wherein the image signal comprising image data and control information wherein the control information comprises functional parameters (C) for the data content of gradual transition areas (R) and position data (P) for gradual transition areas wherein the decoder comprises a reader for reading the control information (C, P), an identifier for identifying the gradual transition areas (R′) and a processor for processing the content of the gradual transition areas and inserting the processed content in the decoded image frame.

22. Decoder as claimed in claim 21, wherein the processing of the content of the gradual transition areas is performed by reconstruction of the content on the basis of the functional parameters (C).
